(19) United States
(12) Patent Application Publication
(10) Pub. No.: US 2025/0178571 A1
(43) Pub. Date: Jun. 5, 2025

(54) WHEEL LIFTING PAD FOR SPORTS CAR

(71) Applicant: Lijun HU, Qingdao (CN)

(72) Inventor: Lijun HU, Qingdao (CN)

(21) Appl. No.: 18/395,382

(22) Filed: Dec. 22, 2023

(30) Foreign Application Priority Data
Dec. 1, 2023 (CN) 202323279816.6

(51) Int. Cl. B60S 9/02

(52) U.S. Cl. CPC B60S 9/02

(57) ABSTRACT

The present disclosure relates to the technical field of automobile accessories, and in particular to a wheel lifting pad for a sports car. The technical solution thereof includes a slope part and a carrying part which are integrally arranged, a dip angle between the slope part and a horizontal plane is ∠α, 10°∠α≤30°, the slope part has a length of d, 20 cm≤d≤50 cm, and a maximum height of h, 10 cm≤h≤15 cm; and a dip angle between the carrying part and the horizontal plane is ∠β, 60°≤∠β≤90°, and an upper end of the carrying part has a sunken arc-shaped inclined plane. The wheel lifting pad provided by the present disclosure has the advantages of a simple structure and a strong adaptability.

### CROSS-REFERENCE TO RELATED PATENT APPLICATION

This application claims the benefit of priority to China Patent Application No. 202323279816.6, filed on Dec. 1, 2023. The entire content of the above identified application is incorporated herein by reference.

### TECHNICAL FIELD

The present disclosure relates to the technical field of automobile accessories, and in particular to a wheel lifting pad for a sports car.

### BACKGROUND

The sports car is a car with smooth body lines, low body height, excellent controllability and strong power. The controllability is concerned when the sports car is designed, due to a short body, a relatively poor passability and a relatively long head of a front-engine sports car, a situation of an underbody is not easily observed during maintenance or repairing, a height from the underbody to the ground is limited, so an operable space for lifting the underbody is small, and few devices for lifting the wheel of the sports car are available in the prior art.

### SUMMARY

To solve the deficiencies existing the prior art, the present disclosure provides a wheel lifting pad for a sports car, with the advantages of a simple structure and a strong adaptability.

The foregoing objective of the present disclosure is achieved by the following technical solution:

The present disclosure provides a wheel lifting pad for a sports car, including a slope part and a carrying part which are integrally arranged, a dip angle between the slope part and a horizontal plane is ∠α, 10°≤∠α≤30°, the slope part has a length of d, 20 cm≤50 cm, and a maximum height of h, 10 cm≤15 cm; and a dip angle between the carrying part and the horizontal plane is ∠β, 60°≤∠β≤90°, and an upper end of the carrying part has a sunken arc-shaped inclined plane.

After adopting the foregoing technical solution, the sports car drives into the lifting pad along the slope part, due to a short body and a relatively long head of the sports car, the length and the dip angle of the slope part fit with characteristics of the sports car, to avoid the occurrence of interference with an underbody, and a suitable length is provided for transiting the sports car to the carrying part. The sunken arc-shaped inclined plane of the carrying part fits with the wheel of the sports car, the wheel will not slide out when located in the carrying part, with an excellent inclusive fixation, the carrying part is formed with a slightly inclined shape, and when the wheel is located in the carrying part, a contact area between the bottom thereof and the ground is greater, so a force applied on the carrying part by the wheel is dispersed to some extent.

Further, the carrying part includes a first left side plate, a first right side plate, a first middle side plate and a rear side plate, the first left side plate, the first right side plate and the first middle side plate are arranged in a manner of being parallel to each other, and one end of the first left side plate, one end of the first right side plate and one end of the first middle side plate all resist to the rear side plate perpendicularly.

After adopting the foregoing technical solution, the first left side plate, the first right side plate, the first middle side plate and the first rear side plate are formed with a frame structure on the carrying part, to support the wheel of the sports car.

Further, an included angle between the first left side plate and the rear side plate or between the first right side plate and the rear side plate is ∠Ω, 80°≤∠Ω≤90°.

After adopting the foregoing technical solution, the rear side plate presents a trapezoid, to disperse the pressure of the carrying part when the wheel is placed on the carrying part, and to increase the stability of the device.

Further, the slope part includes a second left side plate, a second right side plate, a second middle side plate and a front side plate, and the second left side plate, the second right side plate and the second middle side plate are respectively formed by extending the first left side plate, the first right side plate and the first middle side plate to the front side plate.

After adopting the foregoing technical solution, the second left side plate, the second right side plate, the second middle side plate and the front side plate are formed with a frame structure on the slope part, to form a guide path, through which the sports car can drive in.

Further, the rear side plate is provided with a baffle, and the baffle is raised upwards along an upper part of the rear side plate.

After adopting the foregoing technical solution, the baffle that is higher than the carrying part is formed, and the wheel has been blocked and limited.

Further, reinforcing ribs are arranged between the first left side plate and the first middle side plate, between the first right side plate and the first middle side plate, between the second left side plate and the second middle side plate, and between the second right side plate and the second middle side plate, and the reinforcing ribs penetrate through up and down.

After adopting the foregoing technical solution, a weighing capacity of the lifting pad is increased, and an antiskid structure is formed.

Further, the reinforcing ribs are regularly or irregularly arranged.

After adopting the foregoing technical solution, an adaptability of the lifting pad is increased.

Further, the part that the carrying part resists to the slope part is integrally provided with blocking strips.

After adopting the foregoing technical solution, the wheel is further prevented from sliding along the slope part and further limited in combination with the sunken arc-shaped inclined plane of the carrying part.

Further, raised antiskid sites are arranged on the blocking strips.

After adopting the foregoing technical solution, the skid resistance of the blocking strips is increased.

Further, the front side plate and/or the carrying part are provided with hanging holes.

After adopting the foregoing technical solution, the lifting pad is conveniently hung or stored.

In conclusion, the present disclosure includes at least one of the following beneficial technical effects:

The sports car drives into the lifting pad along the slope part, due to the short body and the relatively long head of the sports car, the length and the dip angle of the slope part fit with characteristics of the sports car, to avoid the occurrence of interference with the underbody, and the suitable length is provided for transiting the sports car to the carrying part. The sunken arc-shaped inclined plane of the carrying part fits with the wheel of the sports car, the wheel will not slide out when located in the carrying part, with an excellent inclusive fixation, the carrying part is formed with the slightly inclined shape, and when the wheel is located in the carrying part, the contact area between the bottom thereof and the ground is greater, so the force applied on the carrying part by the wheel is dispersed to some extent.

### BRIEF DESCRIPTION OF THE DRAWINGS

FIG. 1 is a solid schematic diagram of an overall structure of this embodiment.

FIG. 2 is a side view of this embodiment.

FIG. 3 is a top view of this embodiment.

FIG. 4 is a rear view of this embodiment.

In the drawings: 1. Slope part; 11. The second left side plate; 12. The second right side plate; 13. The second middle side plate; 14. Front side plate; 2. Carrying part; 21. Arc-shaped inclined plane; 22. The first left side plate; 23. The first right side plate; 24. The first middle side plate; 25. Rear side plate; 251. Baffle; 3. Hanging hole; 4. Reinforcing rib; 5. Blocking strip; 51. Antiskid site.

### DETAILED DESCRIPTION OF THE EMBODIMENTS

The present disclosure is further described in detail below in combination with drawings.

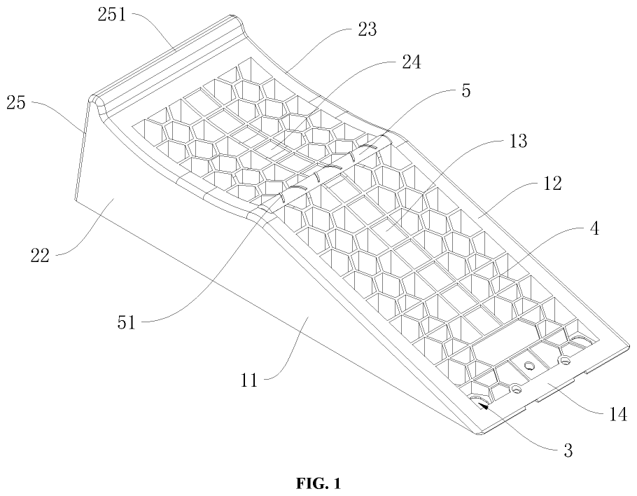

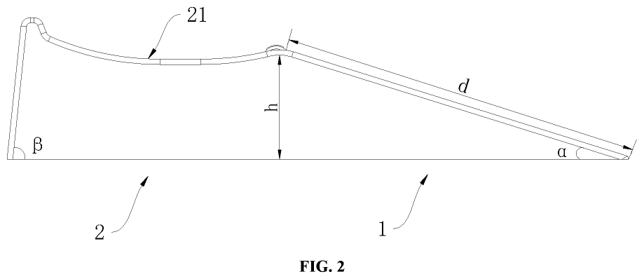

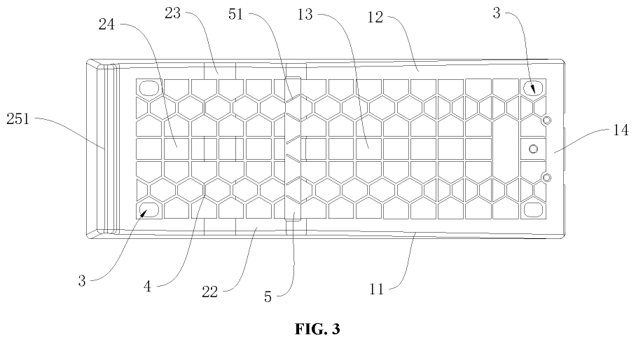

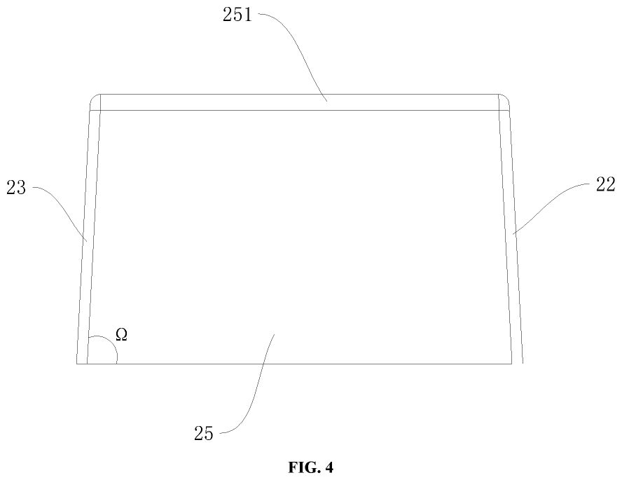

To facilitate the understanding of those skilled in the art to the present disclosure, the specific implementations of the present disclosure are described below in combination with FIGS. 1-4.

Referring to FIGS. 1-4, which is a wheel lifting pad for a sports car, including a slope part 1 and a carrying part 2 which are integrally arranged.

A dip angle between the slope part 1 and a horizontal plane is ∠α, 10°≤∠α≤30°, and in this embodiment, ∠α=17°; the slope part 1 has a length of d, 20 cm≤d≤50 cm, and in this embodiment, d=37 cm; and the slope part 1 has a maximum height of h, 10 cm≤h≤15 cm, and in this embodiment, h=12 cm.

An upper end of the carrying part 2 has a sunken arc-shaped inclined plane 21, a dip angle between the carrying part 2 and the horizontal plane is ∠β, 60°≤∠β≤90°, and in this embodiment, ∠β=°.

The carrying part 2 includes a first left side plate 22, a first right side plate 23, a first middle side plate 24 and a rear side plate 25, the first left side plate 22, the first right side plate 23 and the first middle side plate 24 are arranged in a manner of being parallel to each other, and one end of the first left side plate 22, one end of the first right side plate 23 and one end of the first middle side plate 24 all resist to the rear side plate 25 perpendicularly; a second left side plate 11, a second right side plate 12 and a second middle side plate 13 are respectively formed by extending the first left side plate 22, the first right side plate 23 and the first middle side plate 24 to the front side plate 14, such that both the carrying part 2 and the slope part 1 are formed with frame structures; an included angle between the first left side plate and the rear side plate or between the first right side plate and the rear side plate is ∠Ω, 80°≤∠Ω≤90°, and in this embodiment, ∠Ω=87°; the rear side plate 25 is provided with a baffle 251, and the baffle 251 is raised upwards along an upper part of the rear side plate 25, the baffle 251 that is higher than the carrying part 2 is formed, and the wheel has been blocked and limited; the front side plate 14 and/or the carrying part 2 are provided with hanging holes 3, so the lifting pad is conveniently hung or stored, in this embodiment, symmetrically distributed hanging holes 3 are formed in both sides of the front side plate 14, and two hanging holes symmetrical to each other are formed in a position of the carrying part 2 that is close to the rear side plate 25; reinforcing ribs 4 are arranged between the first left side plate 22 and the first middle side plate 24, between the first right side plate 23 and the first middle side plate 24, between the second left side plate 11 and the second middle side plate 13, and between the second right side plate 12 and the second middle side plate 13, and the reinforcing ribs 4 penetrate through up and down and may be regularly or irregularly arranged.

The part that the carrying part 2 resists to the slope part 1 is integrally provided with blocking strips 5, and raised antiskid sites 51 are arranged on the blocking strips 5, to increase the skid resistance of the blocking strips 5.

The implementation principles of this embodiment are as follows: the sports car drives into the lifting pad along the slope part 1, due to a short body and a relatively long head of the sports car, the length and the dip angle of the slope part 1 fit with characteristics of the sports car, to avoid the occurrence of interference with an underbody, and a suitable length is provided for transiting the sports car to the carrying part 2. The sunken arc-shaped inclined plane 21 of the carrying part 2 fits with the wheel of the sports car, the wheel will not slide out when located in the carrying part 2, with an excellent inclusive fixation, the carrying part 2 is formed with a slightly inclined shape, and when the wheel is located in the carrying part 2, a contact area between the bottom thereof and the ground is greater, so a force applied on the carrying part by the wheel is dispersed to some extent, and the sports car is more stable when placed on the lifting pad.

In the description of the present disclosure, it is noted that orientation or position relationships indicated by the terms “center, “upper”, “lower”, “left”, “right”, “vertical”, “horizontal”, “inner”, “outer” and the like are based on the orientation or position relationships as shown in the drawings, for ease of describing the present disclosure and simplifying the description only, rather than indicating or implying that the mentioned apparatus or element necessarily has a particular orientation and must be constructed and operated in the particular orientation. Therefore, these terms should not be understood as limitations to the present disclosure. In addition, the terms “first”, “second” and “third” are merely used for the description purpose, instead of being understood as indicating or implying relative importance.

In the description of the present disclosure, it is noted that, unless specific regulation and limitation otherwise, terms “install”, “join” and “connect” should be generally understood, for example, may a fixed connection, or a detachable connection, or an integrated connection, may a mechanical connection or an electric connection, may a direct connection or an indirect connection through an intermediation, and may an internal connection of two elements. Those of ordinary skill in the art may understand the specific meaning of the terms in the present disclosure according to specific conditions.

The above is the implementation of the present disclosure, and does not constitute a limitation to the protection scope of the present disclosure. Any modifications, equivalent replacements, improvements and the like made within the spirit and principle of the present disclosure shall be included in the protection scope of the claims of the present disclosure.

What is claimed is:

1. A wheel lifting pad for a sports car, comprising a slope part (1) and a carrying part (2) which are integrally arranged, wherein a dip angle between the slope part (1) and a horizontal plane is ∠α, 10°≤∠α≤30°, the slope part (1) has a length of d, 20 cm≤d≤50 cm, and a maximum height of h, 10 cm≤h≤15 cm; and a dip angle between the carrying part (2) and the horizontal plane is ∠β, 60°≤∠β≤90°, and an upper end of the carrying part (2) has a sunken arc-shaped inclined plane (21).

2. The wheel lifting pad for the sports car according to claim 1, wherein the carrying part (2) comprises a first left side plate (22), a first right side plate (23), a first middle side plate (24) and a rear side plate (25), the first left side plate (22), the first right side plate (23) and the first middle side plate (24) are arranged in a manner of being parallel to each other, and one end of the first left side plate (22), one end of the first right side plate (23) and one end of the first middle side plate (24) all resist to the rear side plate (25) perpendicularly.

3. The wheel lifting pad for the sports car according to claim 2, wherein the slope part (1) comprises a second left side plate (11), a second right side plate (12), a second middle side plate (13) and a front side plate (14), and the second left side plate (11), the second right side plate (12) and the second middle side plate (13) are respectively formed by extending the first left side plate (22), the first right side plate (23) and the first middle side plate (24) to the front side plate (14).

4. The wheel lifting pad for the sports car according to claim 2, wherein the rear side plate (25) is provided with a baffle (251), and the baffle (251) is raised upwards along an upper part of the rear side plate (25).

5. The wheel lifting pad for the sports car according to claim 3, wherein reinforcing ribs (4) are arranged between the first left side plate (22) and the first middle side plate (24), between the first right side plate (23) and the first middle side plate (24), between the second left side plate (11) and the second middle side plate (13), and between the second right side plate (12) and the second middle side plate (13), and the reinforcing ribs (4) penetrate through up and down.

6. The wheel lifting pad for the sports car according to claim 5, wherein the reinforcing ribs (4) are regularly or irregularly arranged.

7. The wheel lifting pad for the sports car according to claim 1, wherein the part that the carrying part (2) resists to the slope part (1) is integrally provided with blocking strips (5).

8. The wheel lifting pad for the sports car according to claim 7, wherein raised antiskid sites (51) are arranged on the blocking strips (5).

9. The wheel lifting pad for the sports car according to claim 3, wherein the front side plate (14) and/or the carrying part (2) are provided with hanging holes (3).

10. The wheel lifting pad for the sports car according to claim 2, wherein an included angle between the first left side plate and the rear side plate or between the first right side plate and the rear side plate is ∠Ω, 80°≤∠Ω≤90°.

11. The wheel lifting pad for the sports car according to claim 3, wherein the rear side plate (25) is provided with a baffle (251), and the baffle (251) is raised upwards along an upper part of the rear side plate (25).
